(19) United States
(12) Patent Application Publication
(10) Pub. No.: US 2026/0304215 A1
(43) Pub. Date: Oct. 1, 2026

(54) WIRELESS COMMUNICATION METHOD AND DEVICE

(71) Applicant: MEDIATEK INC., Hsinchu City (TW)

(72) Inventor: Chih-Kun Chang, Hsinchu City (TW)

(21) Appl. No.: 19/293,149

(22) Filed: Aug. 7, 2025

Related U.S. Application Data
(60) Provisional application No. 63/779,431, filed on Mar. 28, 2025.

(51) Int. Cl. H04W 28/02; H04W 88/10

(52) U.S. Cl. CPC H04W 28/0278; H04W 88/10

(57) ABSTRACT

The application discloses a wireless communication method and device. A station transmits a null packet over a primary channel to notify an access point (AP) that unpredictable traffic data is pending for transmission. The station determines, based on a response or a lack of response from the AP, whether channel access has been successfully obtained. In response to a response from the AP, the station sends the unpredictable traffic data to the AP.

### CROSS-REFERENCE TO RELATED APPLICATION

This application claims the benefit of US provisional Patent application Serial No. 63/779,431, filed Mar. 28, 2025, the disclosure of which is incorporated by reference herein in its entirety.

### TECHNICAL FIELD

The disclosure relates to a wireless communication method and device.

### BACKGROUND

Uplink latency in the Wi-Fi field refers to the delay between the time a device (like the smart phone or laptop) sends data to the wireless access point (AP) and the time the AP actually receives it. It's essentially the round-trip time of the upload path, and it's an important metric for real-time applications like: Video calls, Online gaming, VoIP (voice over IP), and Live streaming.

The term "uplink" refers to the communication from the device (or said station (STA)) to the access point; and the term "downlink" refers to the communication from the access point to the device (or said station (STA)).

The factors that affect uplink latency are for example but not limited by, (1) Wi-Fi signal strength (RSSI): Weaker signal means more retransmissions and thus higher latency; (2) interference coming from other Wi-Fi networks or devices like microwaves or Bluetooth; (3) network congestion: when more devices fighting for airtime, which means more wait time; (4) Wi-Fi protocol/version: Newer standards like Wi-Fi 6 (802.11ax) are better optimized for low latency; (5) device performance: Older or busy devices might take longer to prepare and transmit data; and (6) Quality of Service (QoS): Some routers prioritize certain types of traffic to reduce latency.

Thus, it is an important issue to improve uplink latency in wireless communication technology.

### SUMMARY

According to one embodiment, a wireless communication method is provided. The wireless communication method comprises: transmitting, by a station, a null packet over a primary channel to notify an access point (AP) that unpredictable traffic data is pending for transmission; determining, by the station, based on a response or a lack of response from the AP, whether channel access has been successfully obtained; and in response to a response from the AP, sending, by the station, the unpredictable traffic data to the AP.

According to another embodiment, a wireless communication device is provided. The wireless communication device includes: a communication unit for transmitting and receiving a wireless signal; and a processor coupled to the communication unit. The processor is configured for: transmitting a null packet over a primary channel to notify an access point (AP) that unpredictable traffic data is pending for transmission; determining, based on a response or a lack of response from the AP, whether channel access has been successfully obtained; and in response to a response from the AP, sending the unpredictable traffic data to the AP.

### BRIEF DESCRIPTION OF THE DRAWINGS

FIG. 1 illustrates a configuration of a station according to an embodiment of the present invention.

FIG. 2 shows a wireless communication method according to one embodiment of the application.

FIG. 3 shows a wireless communication method according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In the application, the station (STA) is a predetermined device following Wi-Fi standard. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally coupled to the processor and transmits and receives frames through the wireless network for the station.

The access point (AP) is an entity that provides access via wireless medium for the station associated therewith. Communication among non-AP stations is, in principle, performed via the AP. In the present invention, an AP may also be referred to as a base wireless communication terminal. In addition, the base wireless communication terminal may include various types of wireless communication terminals that allocate medium resources and perform scheduling in communication with a plurality of wireless communication terminals.

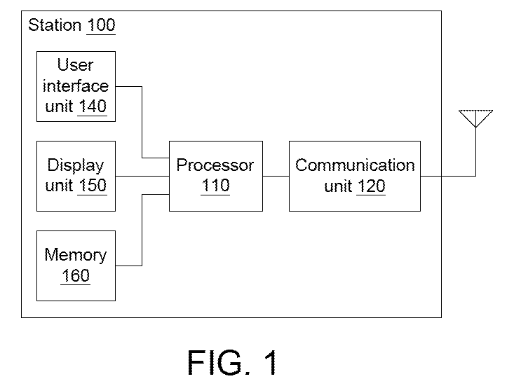

FIG. 1 is a block diagram illustrating a configuration of a station 100 according to an embodiment of the present invention. As illustrated in FIG. 1, the station 100 according to the embodiment of the present invention may include a processor 110, a communication unit 120, a user interface unit 140, a display unit 150, and a memory 160. The processor 110 is coupled to the communication unit 120, the user interface unit 140, the display unit 150, and the memory 160.

The communication unit 120 transmits and receives a wireless signal such as a Wi-Fi packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHz, 6 GHz or the like. The respective communication modules may perform wireless (Wi-Fi) communication with the AP or an external station according to a Wi-Fi standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a Wi-Fi communication module for processing Wi-Fi signals.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like.

Further, the memory 160 stores a control program used in the station 100 and various resulting data. The control program may include an access program required for the station 100 to access the AP or the external station.

The processor 110 may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 may represent a main control unit of the station 100 and according to the embodiment, the processor 110 may represent a control unit for individually controlling some component of the station 100, for example, the communication unit 120, and the like. That is, the processor 110 may include a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 1 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

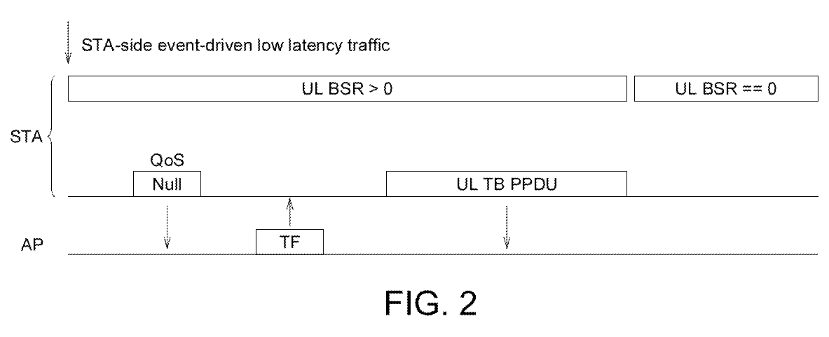

FIG. 2 shows a wireless communication method according to one embodiment of the application.

When the station receives station-side event driven low latency traffic, the UL (uplink) BSR of the station is set to be larger than 0. The Buffer Status report (BSR) carries the information on how much data in UL buffer of the station is to be sent out. The BSR is a MAC (media access control) layer procedure which is used by the station to provide information about the amount of data available for transmission in the UL buffers to the serving AP.

In the application, after the station receives station-side event driven low latency traffic, the station actively sends out a short and preemptive QoS (quality of service)-null frame to update its BSR to the AP when the station has pending UL data. The QoS-null frame is sent only when BSR of the station becomes non-zero (when an “empty to nonempty” event occurs, that is, when the station receives station-side event driven low latency traffic). Also, it is preferred not to create too much contention in 2.4 GHz band.

After the AP receives the short and preemptive QoS-null frame from the station, the AP sends a trigger frame (TF) to the station. In Wi-Fi (especially starting from 802.11ax / Wi-Fi 6), a trigger frame has these main functions: (1) coordinating multiple devices: TF tells multiple devices when and how they can transmit uplink data at the same time without colliding; (2) resource allocation: TF assigns specific Resource Units (RUs) (small chunks of frequency and time) to each device, so each device knows exactly where and when to send their data; (3) reduce contention: Instead of all devices randomly contenting to send contention message (which causes delays), the AP (Access Point) organizes the transmission smoothly using the Trigger Frame; and (4) optimizing power saving: devices can sleep until their assigned time slot, which saves battery, very important for IoT and mobile devices.

After receiving TF from the AP, the station sends the event-driven LL (low latency) traffic in the UL TB (trigger-based) physical layer protocol data unit (PPDU) to the AP.

After the station sends all the event-driven LL (low latency) traffic, the UL BSR of the station is equal to zero. So, uplink of the event-driven LL (low latency) traffic received by the station is completed.

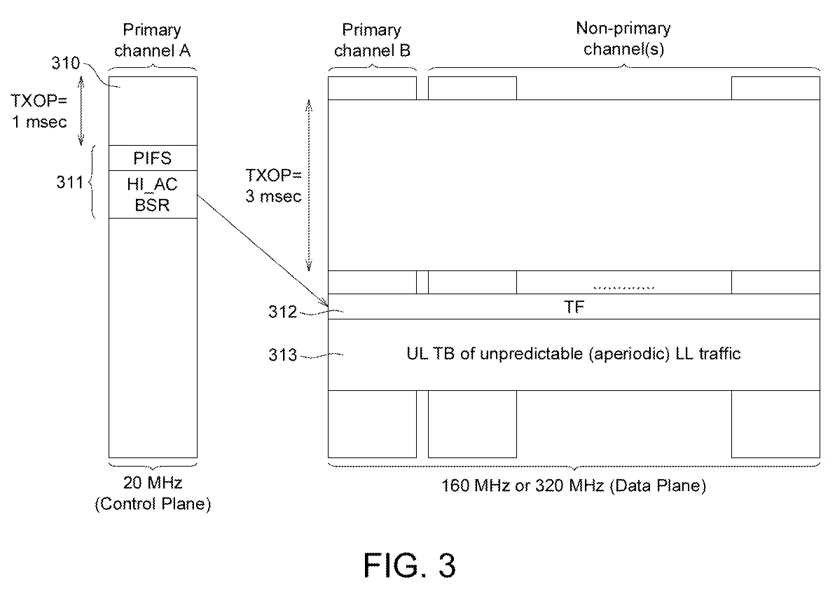

FIG. 3 shows a wireless communication method according to one embodiment of the application. In FIG. 3, the primary channel A of the control plane is for example but not limited by, 20MHz under 2.4GHz; and the primary channel B and non-primary channels of the data plane are for example but not limited by, 160MHz or 320MHz under 5GHz or 6GHz.

After the station receives station-side event driven low latency traffic, at step 310, the transmission opportunity “TXOP” is set as TXOP_limit=1 ms, which is to reduce throughput efficiency but improve preemptive BSR indication delay. TXOP is available in QoS mode as part of EDCA (Enhanced Distributed Channel Access), and it is a limited time period of contention-free channel access available to the channel-owning station. During such a period, the station can send multiple frames that belong to a particular access category. Transmit opportunity (TXOP) is a MAC feature in 802.11, which increases throughput for high priority data by providing contention-free channel access for a period of time.

In step 310, also, the parameter “MU_EDCA timeout” is set as equal to zero “MU_EDCA timeout=0”. By this setting, the preemptive BSR do not wait for MU_EDCA timeout like normal Data.

At step 311, a preemptive BSR (QoS Null, with high access category (AC)) contention with PIFS and CW=0, 1 or 3 (according to BSS’s EDCA parameter) is generated by the station on the control plane only when high priority AC queue status is changed from empty to nonempty (which is non-periodic, unpredictable). In one embodiment of the application, the high priority QoS data delivery waits for the TF generated by the AP in any of the available links.

More precisely, access categories have different channel access parameters, such as AIFS (Arbitration Interframe Spacing), duration, contention window size, and TXOP limit. In the default EDCA OFDM parameter set in the 802.11 standard, these values are set so that higher priority packets are favored (the MAC waits less before sending them, the contention window is smaller, and they can be sent in a TXOP). The default parameter set specifies a TXOP limit of approximately 3 ms for the video category, and 1.5 ms for the voice category. The background and best effort categories have a TXOP limit of 0, that is, they do not use TXOP.

A station can send frames to multiple recipients during a TXOP. In addition to QoS data frames, other frames can be exchanged in the course of the TXOP, such as ACK and BlockAckReq/BlockAck frames, and other control and management frames.

At step 312, after the AP receives the short and preemptive QoS-null frame from the station, the AP sends a trigger frame (TF) to the station.

After receiving TF from the AP, at step 313, the station sends the event-driven unpredictable (aperiodic) LL (low latency) traffic in the UL TB PPDU to the AP.

After the station sends all the event-driven LL (low latency) traffic, the UL BSR of the station is equal to zero. So, uplink of the event-driven LL (low latency) traffic received by the station is completed.

In one embodiment of the application, the station retransmits the QoS-null frame upon determining that channel access has not been obtained.

In one embodiment of the application, determining by the station that channel access has not been obtained comprises detecting an absence of acknowledgment from the AP within a predefined time interval.

In one embodiment of the application, the station retransmits the QoS-null frame after a random backoff period.

In one embodiment of the application, in order to leverage multi-link operation (MLO) high/low bandwidth links, the station uses a small bandwidth BSS (for ex: 2.4GHz/20Mhz bandwidth) as preemptive BSR indication channel; and the station sets the parameter TXOP_limit to a smaller value (say, 1 msec) in the BSR indication channel. Upon the arrival of non-periodic low latency traffic, the STA uses aggressive channel access parameter (for ex: PIFS) to send a QoS-Null Data frame with BSR of high priority AC to the AP. When the AP has received the BSR indication of non-periodic low latency data, the AP may schedule TF in the high bandwidth channel (for ex: 5GHz/160MHz). Also, in one embodiment of the application, MLO cross-link power-save-wakeup indication is to be considered.

In some embodiments, the control plane may utilize a primary channel A to transmit a short packet, such as a Buffer Status Report (BSR), to notify an Access Point (AP) that a Station (STA) has data pending for transmission. If no response is received from the AP, the STA may more rapidly determine whether channel access was successfully obtained. In cases where the STA fails to acquire the channel, the STA may promptly retransmit the BSR, thereby reducing transmission latency.

Conversely, in prior art, the STA transmits data directly over the primary channel A without first sending the BSR, a longer period may be required to determine whether the transmission has failed (i.e., whether channel access was unsuccessful).

In one embodiment of the application, disclosed is a method for reducing transmission latency in a wireless communication system, comprising: transmitting, by a station (STA), a null packet over a primary channel to notify an access point (AP) that unpredictable traffic data is pending for transmission; determining, by the STA, based on a response or a lack of response from the AP, whether channel access has been successfully obtained; and in response to a response from the AP, the station sends the unpredictable traffic data to the AP.

The method for reducing transmission latency in a wireless communication system further comprises: wherein retransmitting, by the STA, the null packet upon determining that channel access has not been obtained.

In the method for reducing transmission latency in a wireless communication system, the null packet comprises a Buffer Status Report (BSR).

In the method for reducing transmission latency in a wireless communication system, determining that channel access has not been obtained comprises detecting an absence of acknowledgment from the AP within a predefined time interval.

In the method for reducing transmission latency in a wireless communication system, retransmitting the null packet is performed after a random backoff period.

In other words, in some embodiments of the application, a method for reducing transmission latency in a wireless communication system may have the following features: (1) Transmission of Short Packet (BSR): On the control plane, the Station (STA) may transmit a short packet, such as a Buffer Status Report (BSR), over a primary channel A to notify an Access Point (AP) that the STA has data pending for transmission; (2) determination of Channel Access Success: if no response is received from the AP, the STA may quickly determine that channel access was not successfully obtained; (3) Retransmission of BSR: Upon determining that channel access has failed, the STA may promptly retransmit the BSR, thereby allowing for a faster retry and reducing overall transmission latency.

As for comparison with Direct Data Transmission used in the prior art, if the STA transmits data directly over the primary channel A without first transmitting the BSR, it may take a longer period for the STA to determine whether the transmission was successful or failed (i.e., due to failure to gain channel access).

The above primarily describes the solutions provided in the embodiments of the present application from the perspective of feature extraction. It is understood that to achieve the above functions, the station includes corresponding hardware structures and/or software modules that execute functions. Professionals in the technical field can easily recognize that the units and algorithm steps described in the embodiments of the present application can be implemented in hardware form or a combination of hardware and computer software. Whether the functions are performed by hardware or by hardware driven by computer software depends on the specific application and design constraints of the technical solution. Professionals in the technical field can use different methods to implement the functions described in each specific application without departing from the scope of the present application.

In one embodiment of the present application, the station can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A wireless communication method comprising:
transmitting, by a station, a null packet over a primary channel to notify an access point (AP) that unpredictable traffic data is pending for transmission;
determining, by the station, based on a response or a lack of response from the AP, whether channel access has been successfully obtained; and
in response to a response from the AP, sending, by the station, the unpredictable traffic data to the AP.

2. The wireless communication method according to claim 1 further comprising: retransmitting, by the station, the null packet upon determining that channel access has not been obtained.

3. The wireless communication method according to claim 1, wherein the null packet comprises a buffer status report (BSR).

4. The wireless communication method according to claim 1, wherein determining that channel access has not been obtained comprises detecting an absence of acknowledgment from the AP within a predefined time interval.

5. The wireless communication method according to claim 1, wherein the station retransmits the null packet after a random backoff period.

6. A wireless communication device comprising:
a communication unit for transmitting and receiving a wireless signal; and
a processor coupled to the communication unit,
wherein the processor is configured for:
transmitting a null packet over a primary channel to notify an access point (AP) that unpredictable traffic data is pending for transmission;
determining, based on a response or a lack of response from the AP, whether channel access has been successfully obtained; and
in response to a response from the AP, sending the unpredictable traffic data to the AP.

7. The wireless communication device according to claim 6, wherein the processor is configured for: retransmitting the null packet upon determining that channel access has not been obtained.

8. The wireless communication device according to claim 6, wherein the null packet comprises a buffer status report (BSR).

9. The wireless communication device according to claim 6, wherein the processor is configured for: determining that channel access has not been obtained if detecting an absence of acknowledgment from the AP within a predefined time interval.

10. The wireless communication device according to claim 6, wherein the processor is configured for: retransmitting the null packet after a random backoff period.
